(19) United States
(12) Patent Application Publication
(10) Pub. No.: US 2012/0164348 A1
(43) Pub. Date: Jun. 28, 2012

(54) METHOD FOR THE STRUCTURED COATING OF SUBSTRATES

(75) Inventors: Birger Zimmermann, Freiburg (DE); Michael Niggemann, Cambridge (GB); Hans-Frieder Schleiermacher, Freiburg (DE)

(73) Assignees: Albert-Ludwigs-Universitat Freiburg, Freiburg (DE); Fraunhofer-Gesellschaft Zur Forderung Der Angewandten Forschung E.V., Munich (DE)

(21) Appl. No.: 13/301,104

(22) Filed: Nov. 21, 2011

Related U.S. Application Data
(63) Continuation of application No. PCT/EP2010/003275, filed on May 28, 2010.

(30) Foreign Application Priority Data
May 29, 2009 (DE) 102009023403.9

(51) Int. Cl. B05D 3/06; B05D 5/12; B82Y 40/00

(52) U.S. Cl. 427/555; 427/286; 427/58; 427/600; 427/8; 118/669; 977/890

(57) ABSTRACT

The invention relates to a method for the structured coating of substrates from liquid phase and also to a device for the structured coating. Furthermore, the invention includes the use of the method.

### PRIORITY INFORMATION

The present invention is a continuation of PCT Application No. PCT/EP2010/003275 filed on May 28, 2010, that claims priority to German Application No. DE102009023403.9 filed on May 29, 2009, both are incorporated herein by reference in their entireties.

### BACKGROUND OF THE INVENTION

The invention relates to a method for the structured coating of substrates from liquid phase and also to a device for the structured coating. Furthermore, the invention includes the use of the method.

Surface coating methods are known from the state of the art. The production of defined structured surfaces can be effected by printing methods, such as e.g. ink jet printing, gravure printing or offset printing. With the respective methods, specific demands are placed on the rheological properties of the coating materials. Current methods for applying surface coatings are so-called slot die coating and curtain coating.

In the case of slot die coating, the material to be applied in liquid phase, e.g. in solvent or as a thermoplastic, is pressed through a narrow gap and transferred to the product web after emerging from the gap opening. The die and the substrate hereby have a small spacing relative to each other.

Curtain coating differs herefrom primarily by a larger spacing between die and substrate. This leads to the formation of a closed curtain of the coating solution.

What is crucial for successful coating by means of the slot coating method is the defined interplay of the different pressures in the slot dies and also on the forming menisci between product web and substrate or slot die lips on the front- and rear-side of the slot die.

However, frequently complete coatings are not desired, rather a longitudinal structuring or separation of closed coated surfaces in order to obtain separated strips and regions of a specific width. A structured coating can be effected for example by inserting a mask in the coating die.

Structuring by means of an insertion mask is known from the state of the art. However, clean separation of the strips, especially in the case of extremely low-viscous media, having i.e. <10 mPas, and narrow separation lines (below a few millimetres), is very susceptible to disruption. Furthermore, the parameters required for stable coating can only be adjusted technically with very high complexity or not at all.

Because of the defined measurements of the insertion mask, individual variation of the strip width and also the strip spacings of the structuring is not possible during the coating process. Merely by means of the coating parameters, such as web speed, die spacing, conveying volume, starting angle of the die, can the widths of uncoated lines or regions be influenced to a limited degree.

### SUMMARY OF THE INVENTION

Starting herefrom, it is the object of the present invention to eliminate the disadvantages of the state of the art and to provide a method for the structured coating of substrates which enables in particular coating with low-viscous materials.

This object is achieved by the method having the features of claim 1. Claim 21 relates to a device, claim 24 to the use of the method. Further advantageous embodiments are contained in the dependent claims.

According to the invention, a method for the structured coating of substrates from liquid phase is provided, in which a coating film is deposited by means of a surface coating method from liquid phase. In this method, the release of the liquid phase is interrupted at least in regions by targeted disruption to the surface coating method, as a result of which coated and uncoated regions are produced on the substrate.

Preferably, surface coating methods are selected here from the group consisting of slot coating, curtain coating, knife-coating, extrusion and also combinations hereof. By introducing defined disruptions in a surface coating process, tearing of the coating film and hence the formation of coated and uncoated regions is made possible. As a function of the liquid phases used, the suitable method is chosen from those mentioned above.

Interruption in the coating can be effected by a pressure- and/or temperature change in the die, at the release point of the liquid phase and/or after release of the liquid phase. The structuring method according to the invention thereby specifically uses the failure mechanism, e.g. of the slot die coating method, by deliberately introducing a pressure variation at the front slot die gap by means of an air nozzle. As a result, the coating in a defined region becomes unstable and peels off so that a fine separation line and hence the desired strip pattern is produced. There is thereby understood by an air nozzle, an arrangement which makes it possible to produce an airflow of a defined cross-section with a defined volume flow.

In a method variant, at least one further medium can be supplied in the die at the release point of the liquid phase and/or after release of the liquid phase.

Hence a particular variability in the surface structuring is possible. Furthermore, widening of the viscosity range can be made possible by supplying a further medium.

The medium is preferably selected from the group consisting of solvents, inert materials, supplements, doping agents, dielectrics, plastic materials, organic and inorganic semiconductors in liquid phase, conducting pastes and/or mixtures hereof. The conducting pastes can contain graphite, silver, carbon nanotubes, graphs and/or semiconductors. For example coloured strips and also regions can be produced by this addition. Also other variants of the surface design with variable width and variable spacing are conceivable here.

The pressure change is effected preferably by an airflow directed towards the release point of the liquid phase. Via adjustable nozzles, the profile and the volume flow of the airflow can hence be adjusted. Furthermore, the width and/or the position of the coating can be varied by speed change in the airflow.

The width and/or the position of the coating can be effected by the die shape, in particular by changing the die shape by means of a rotating piezo element, and/or by changing the position of the die.

In one variant of the method according to the invention, the interruption in the coating can be produced by an ultrasound device. Furthermore, this interruption in the coating film or the coating can be produced by at least one laser beam and/or heating wire.

In a method variant, at least one insertion mask can be inserted in addition.

Furthermore, structuring parallel to the direction of movement of the substrate can be produced by targeted disruption over the total length of the substrate.

Structuring perpendicular to the direction of movement of the substrate can be produced by targeted disruption over the entire width of the substrate.

The width and position of the strips can be varied by changes in the airflows, e.g. by displacing the air nozzles, without changing the slot die or the insertion mask during the coating. By combining the insertion mask and air nozzles, more robust structuring relative to undesired disruptive influences can possibly be achieved. A transverse structuring, which is based on the same principle, is therefore also conceivable if the coating can be interrupted by a specific impact of air over the entire width of the slot die or the disruption by the air nozzle(s) can be displaced so rapidly that in fact a transverse structuring is produced.

Preferably, the liquid phase is selected from the group consisting of adhesives, paints, metallic paints, varnishes, in particular silver conducting varnishes, solgel, thermoplastics, organic solvents, organic semiconductors, inorganic semiconductors, organic conductors, inorganic conductors, organic semiconductor nanoparticles, inorganic semiconductor nanoparticles, organic conductor nanoparticles, inorganic conductor nanoparticles, precursors and/or mixtures hereof.

Hence a large bandwidth for the coating and laminating of web-shaped materials is produced.

For the method according to the invention, the substrate is selected preferably from the group consisting of paper, glass, fabrics, materials, plastic materials, plastic material films, metal foils, natural materials, in particular leather, cork, latex and/or composites thereof.

For example foils made of aluminium, copper or other metals are conceivable here. Furthermore, films made of polymers, such as e.g. polyethylene or polypropylene and composites thereof, can be used. All web-shaped materials can be used for the method according to the invention.

For a preferred variant of the method, the viscosity of the liquid phase is in the range between 0 and 100 mPas. Hence an optimum coating result is achieved for the surface.

The position of the edges of the coating can be determined by detection. The detection is effected preferably by means of a camera, photoelectric barrier, infrared, optical methods and also line detectors. Adjustment of the air nozzles can be regulated via detection of the position of the edges. Hence precise adjustment of the structuring process (line width and position) by a control loop is possible. The variability of the coating surfaces (width, spacing, position) during the coating process and between two successive coating batches is thus made possible.

According to the invention, the device for the structured coating of substrates from liquid phase, comprising a surface coater with an release point for the liquid phase, has a unit for targeted interruption, at least in regions, of the release of the liquid phase. This device enables coating of surfaces by means of the already described method.

Preferably, the unit is a unit for producing pressure variations in front of and/or at the release point, in particular at least one nozzle for an airflow, a unit for producing ultrasound and/or a unit for producing at least one laser beam. Hence a large bandwidth of the surface structuring, as a function of the liquid phase used and also the substrate, is made possible.

The spacing between the release point for the liquid phase and the substrate is preferably between 0 and 1 m, preferably between 0 and 5 cm, particularly preferred between 0 and 5 mm, in particular between 0 and 0.5 mm.

Furthermore, the invention includes the use of the already described method for the production of chips, solar cells, biochips, LEDs, organic electronics, printed electronics and also decorative elements.

The subject according to the invention is intended to be explained in more detail with reference to the subsequent Figures without wishing to restrict said subject to these variants.

### DETAILED DESCRIPTION OF THE ILLUSTRATED EMBODIMENTS

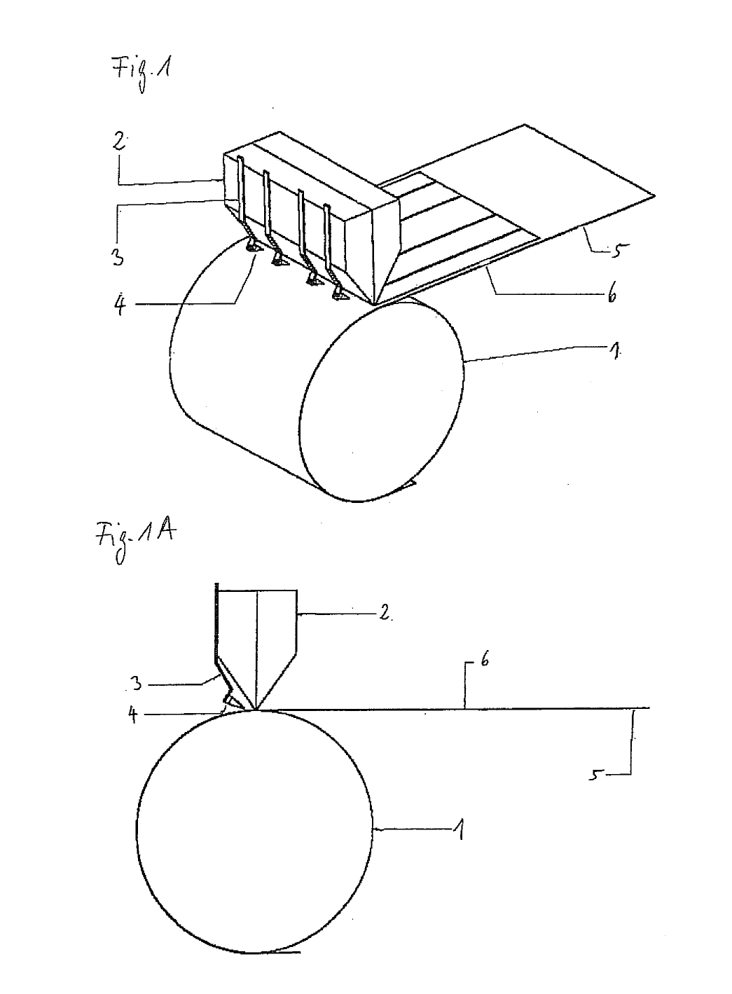

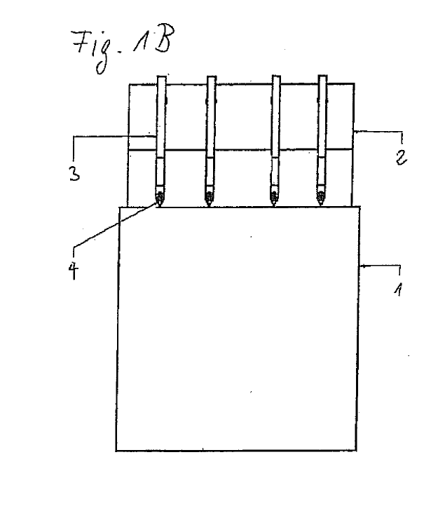

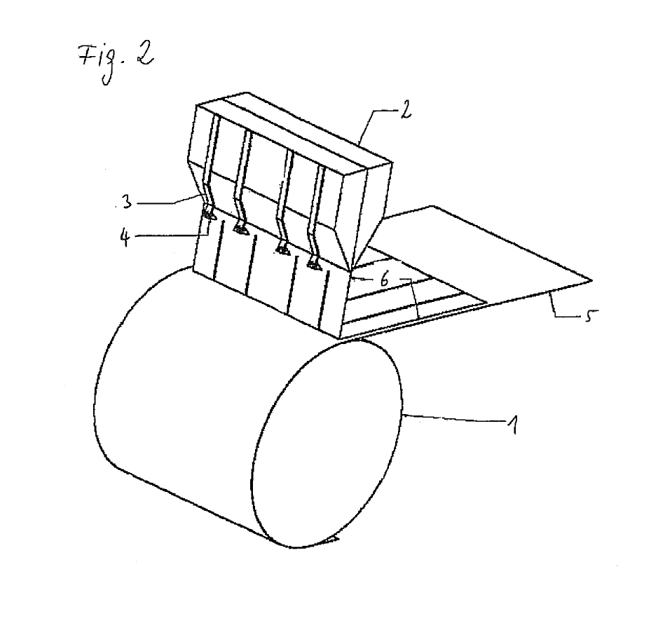

FIG. 1 shows a device for structured coating by means of slot die coating.

FIG. 1A shows a device for structured coating by means of slot die coating as a side view.

FIG. 1B shows a device for structured coating by means of slot die coating as a front view.

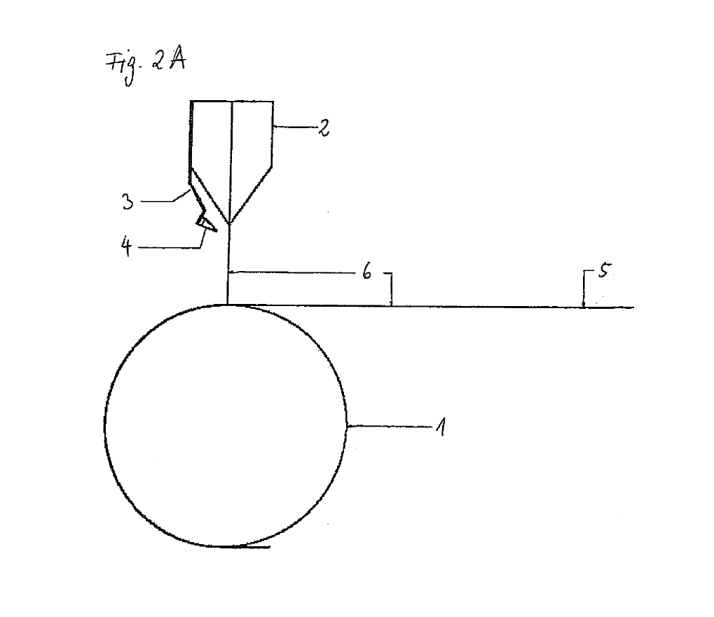

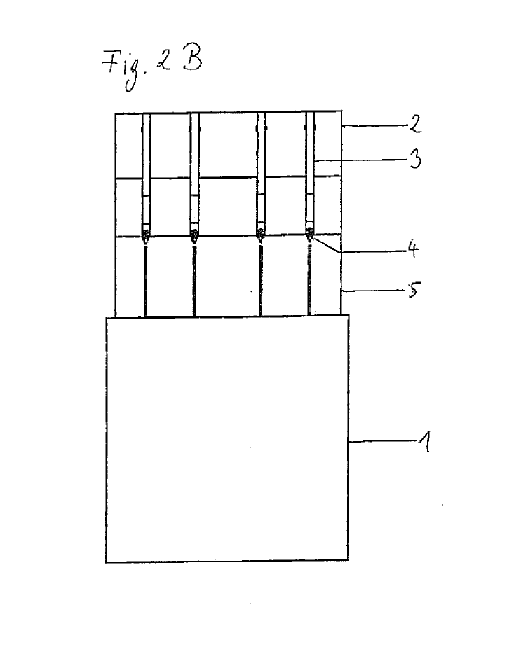

FIG. 2 shows a device for structured coating by means of curtain coating.

FIG. 2A shows a device for structured coating during curtain coating as a side view.

FIG. 2B shows a device for structured coating during curtain coating as a front view.

In FIG. 1, a device for structured coating by means of slot die coating is represented. Positioning units 3 which have air nozzles 4 on their underside are fitted on the slot die 2. The substrate 5 is provided with the coating film 6 and transported via the guide roller 1.

In FIG. 1A, the side view of a device for structured coating by means of slot die coating is represented. The substrate 5 is provided with a coating film 6 and guided via the guide roller 1. The liquid phase is applied on the substrate 5 via the slot die 2. The positioning unit 3 serves for guiding the air nozzles 4.

FIG. 1B shows an illustration of the device for structured coating by means of slot die coating as a front view. The air nozzles 4 are fitted on the slot die 2 via the positioning units 3. Said slot die is guided via the guide roller 1.

FIG. 2 shows a device for structured coating during curtain coating. The substrate 5 is provided with a coating film 6 and conducted via a guide roller 1. The liquid phase is applied by means of a slot die 2 which has a positioning unit 3 which is fitted on the slot die 2 for positioning the air nozzles 4.

In FIG. 2A, this side view of a device for structured coating during curtain coating is represented. The coating film 6 is applied on the substrate 5, which is guided via a guide roller, via a slot die 2. Furthermore, the slot die 2 has a positioning unit 3 with air nozzles 4.

FIG. 2B shows the front view of a device for structured coating during curtain coating. The positioning unit 3, which positions the air nozzles 4, is disposed on the slot die 2. The substrate 5 is guided via the guide roller 1.

What is claimed is:

1. A The method for the structured coating of substrates from liquid phase, in which a coating film is deposited by means of a surface coating The method from liquid phase,
wherein the release of the liquid phase is interrupted at least in regions by targeted disruption to the surface coating The method, as a result of which coated and uncoated regions are produced on the substrate.

2. The method according to claim 1, wherein the surface coating The method is selected from the group consisting of slot coating, curtain coating, knife-coating, extrusion and also combinations hereof.

3. The method according to claim 1, wherein the interruption in the coating is effected by a pressure- and/or temperature change in the die, at the release point of the liquid phase and/or after release of the liquid phase.

4. The method according to claim 3, wherein at least one further medium is supplied in the die at the release point of the liquid phase and/or after release of the liquid phase.

5. The method according to claim 4, wherein the further medium is selected from the group consisting of solvents, inert materials, supplements, doping agents, dielectrics, plastic materials, organic and inorganic semiconductors in liquid phase, conducting pastes and/or mixtures hereof.

6. The method according to claim 5, wherein the conducting pastes contain graphite, silver, carbon nanotubes, graphs and/or doped semiconductors.

7. The method according to claim 3, wherein the pressure change is effected by an airflow directed towards the release point of the liquid phase.

8. The method according to claim 1, wherein the width and/or the position of the coating is varied by a speed change in the airflow.

9. The method according to claim 1, wherein the width and/or the position of the coating is varied by the die shape, in particular by changing the die shape by means of a rotating piezo element, and/or by changing the position of the die.

10. The method according to claim 1, wherein the interruption in the coating is produced by an ultrasound device.

11. The method according to claim 1, wherein the interruption in the coating is produced by at least one laser beam and/or heating wire.

12. The method according to claim 1, wherein at least one insertion mask is inserted in addition.

13. The method according to claim 1, wherein structuring parallel to the direction of movement of the substrate is produced by targeted disruption over the entire length of the substrate.

14. The method according to claim 1, wherein structuring perpendicular to the direction of movement of the substrate is produced by targeted disruption over the entire width of the substrate.

15. The method according to claim 1, wherein the liquid phase is selected from the group consisting of adhesives, paints, metallic paints, varnishes, in particular silver conducting varnishes, solgel, thermoplastics, organic solvents, organic semiconductors, inorganic semiconductors, organic conductors, inorganic conductors, organic semiconductor nanoparticles, inorganic semiconductor nanoparticles, organic conductor nanoparticles, inorganic conductor nanoparticles, precursors and/or mixtures hereof.

16. The method according to claim 1, wherein the substrate is selected from the group consisting of paper, glass, fabrics, materials, plastic materials, plastic material films, metal foils, natural materials, in particular leather, cork, latex and/or composites thereof.

17. The method according to claim 1, wherein the viscosity of the liquid phase is in the range between 0 and 100 mPas.

18. The method according to claim 1, wherein the position of the edges of the coating is determined by detection.

19. The method according to claim 18, wherein the detection is effected by means of a camera, photoelectric barrier, infrared, optical method and/or line detector.

20. The method according to claim 18, wherein the adjustment of the air nozzles is regulated via detection of the position of the edges.

21. A device for the structured coating of substrates from liquid phase comprising a surface coater with an release point for the liquid phase, wherein the device has a unit for targeted interruption, at least in regions, of the release of the liquid phase.

22. The device according to claim 21, wherein the unit is a unit for producing pressure variations in front of and/or at the release point, in particular at least one nozzle for an airflow, a unit for producing ultrasound and/or a unit for producing at least one laser beam.

23. The device according to claim 21, wherein the spacing between the release point for the liquid phase and the substrate is between 0 and 1 m, preferably between 0 and 5 cm, particularly preferred between 0 and 5 mm, in particular between 0 and 0.5 mm.

24. A use of the method according to claim 1 for the production of chips, solar cells, biochips, LEDs, organic electronics, printed electronics, decor.
